(19) United States
(12) Patent Application Publication
(10) Pub. No.: US 2009/0000779 A1
(43) Pub. Date: Jan. 1, 2009

(54) Single-loop cooling system having dual radiators

(75) Inventors: Christopher Dale Hickam, Glasford, IL (US); Timothy Alan Evans, Peoria, IL (US); Kris William Johnson, Peoria, IL (US); Kranthi Kumar Kothamachu, Peoria, IL (US); Larry Michael Slone, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/819,883

(22) Filed: Jun. 29, 2007

(51) Int. Cl. G05D 23/19

(52) U.S. Cl. 165/299

(57) ABSTRACT

A cooling system for use with a heat source is disclosed. The cooling system has an oil cooler, a fluid pump driving fluid through the cooling system, a first heat exchanger, and a first bypass line to direct fluid around the first heat exchanger. The cooling system also has a first electrically-controlled valve to selectively direct at least a portion of the fluid to at least one of the first heat exchanger and the first bypass line based on a fluid temperature. The cooling system further has a second heat exchanger, and a second bypass line to direct fluid around the second heat exchanger. The cooling system additionally has a second electrically-controlled valve located upstream of the oil cooler and configured to selectively direct at least a portion of the fluid to at least one of the second heat exchanger and the second bypass line based on an oil temperature.

This invention was made with Government support under DOE Contract No. DE-FC26-04NT42189 awarded by the U.S. Department of Energy. Accordingly, the Government may have certain rights to this invention.

### TECHNICAL FIELD

The present disclosure relates generally to a cooling system and, more particularly, to a single-loop cooling system having dual radiators.

### BACKGROUND

Engines, including diesel engines, gasoline engines, and gaseous fuel-powered engines are used to generate a mechanical, hydraulic, or electrical power output. In order to accomplish this power generation, an engine typically combusts a fuel/air mixture. This combustion process generates large amounts of heat and, in order to ensure proper and efficient operation of the engine, a cooling system is required to cool fluids directed into or out of the engine, such as, for example, coolant fluid and engine oil. The cooling system typically has a radiator designed to cool the coolant fluid by dissipating heat from the coolant into the atmosphere, and an oil cooler designed to cool the oil by transferring heat from the oil to the coolant fluid.

The size of the engine, power output of the engine, and/or exhaust emissions from the engine may be at least partially dependent on the amount of cooling provided to the engine. That is, the engine may have a most efficient operating temperature range, and operation of the engine may be limited by the ability of the associated exchangers to maintain the engine's temperatures within the optimum range. In some cases, such as, for example, when the engine is operated with a load of about 25% to 50%, it is be desirable to maintain a relatively high engine temperature. In particular, the top-tank temperature (i.e. the temperature of the coolant fluid near the point where it exits the engine) may be kept relatively high to increase the efficiency of the engine.

Similarly, fluids directed through the engine such as, for example, engine oil, may also have a most efficient operating temperature range. That is, the engine oil may lubricate the engine most efficiently within an optimum temperature range, and degrade when operated above the optimum range.

One way to ensure proper engine and engine oil temperature is to include multiple radiators in the cooling system. One such system was disclosed in U.S. Patent Application Publication 2005/0000473 (“the '473 publication”) by Ap et al. on Jan. 6, 2005. Specifically, the '473 publication disclosed a system including a main system and a secondary loop. The main system includes a heat engine, a main pump for driving coolant into the engine, and a main cooling radiator. The main system also includes a short-circuit pipeline, a heating pipeline with an air heater, and any number of equipment exchangers (e.g. an oil cooler) for cooling or heating components of an associated vehicle. A thermostat selectively controls the flow of coolant from the engine toward the main cooling radiator and the short-circuit pipeline, and/or toward the heating pipeline and the equipment exchangers. The secondary loop includes a secondary radiator, a secondary pump for driving coolant into the secondary radiator, and any number of equipment exchangers for cooling or heating components of the associated vehicle. The main system and the secondary loop are connected by one or more multi-way valves that serve to selectively direct coolant between the main system and the secondary loop, or to isolate the main system and the secondary loop based on a control parameter of the load state of the engine, such as, for example, a temperature of the coolant. In this manner, the flow of coolant through the cooling system is controlled to heat and/or cool the engine and the equipment exchangers for various operating states (i.e. based on the control parameter).

While the system of the '473 publication may use multiple radiators to cool and/or heat an engine and other associated components, it may be expensive and large. Specifically, because the system of the '473 publication uses two separate pumps, two distinct piping loops, and complicated valve arrangements, it may be prohibitively expensive and may take up a relatively large amount of under-hood space.

Further, because the system of the '473 patent uses only a control parameter of the load state of the engine to control its valves, the system's effectiveness may be limited. More specifically, the system of the '473 patent does not take characteristics of non-coolant fluids (e.g. engine oil) into account when controlling its valves. Thus, if, for example, the engine is run in a mode during which a coolant temperature is kept desirably high, the oil temperature may become undesirably high, and the valves of the '473 patent may be controlled just the same as if the oil temperature was too low under the same load state of the engine. That is, the system of the '473 patent may fail to cool the oil sufficiently.

The disclosed cooling system is directed to overcoming one or more of the problems set forth above.

### SUMMARY OF THE INVENTION

In one aspect, the present disclosure is directed to a cooling system for use with a heat source. The cooling system includes an oil cooler, a fluid pump configured to drive fluid through the cooling system, a first heat exchanger, and a first bypass line configured to direct fluid from the heat source around the first heat exchanger. The cooling system also includes a first electrically-controlled valve configured to selectively direct at least a portion of the fluid from the heat source to at least one of the first heat exchanger and the first bypass line based on a temperature of the fluid. The cooling system further includes a second heat exchanger located downstream of and in series with the first heat exchanger, and a second bypass line configured to direct fluid around the second heat exchanger. The cooling system still further includes a second electrically-controlled valve located upstream of the oil cooler and configured to selectively direct at least a portion of the fluid to at least one of the second heat exchanger and the second bypass line based on a temperature of oil.

In another aspect, the present disclosure is directed to a method for managing the temperatures of a heat source and oil circulated through the heat source. The method includes driving fluid through a main circuit, selectively branching at least a portion of the fluid through at least one of a first branch and a second branch based on a temperature of the fluid, cooling the fluid in the first branch, and joining the fluid from the first branch and the second branch. The method also includes selectively branching at least a portion of the fluid through at least one of a third branch and a fourth branch based on a temperature of the oil, cooling the fluid in the third branch, and joining the fluid from the third branch and the fourth branch. The method further includes cooling the oil.

### BRIEF DESCRIPTION OF THE DRAWINGS

FIG. 1 is a schematic illustration of an exemplary disclosed cooling system.

### DETAILED DESCRIPTION

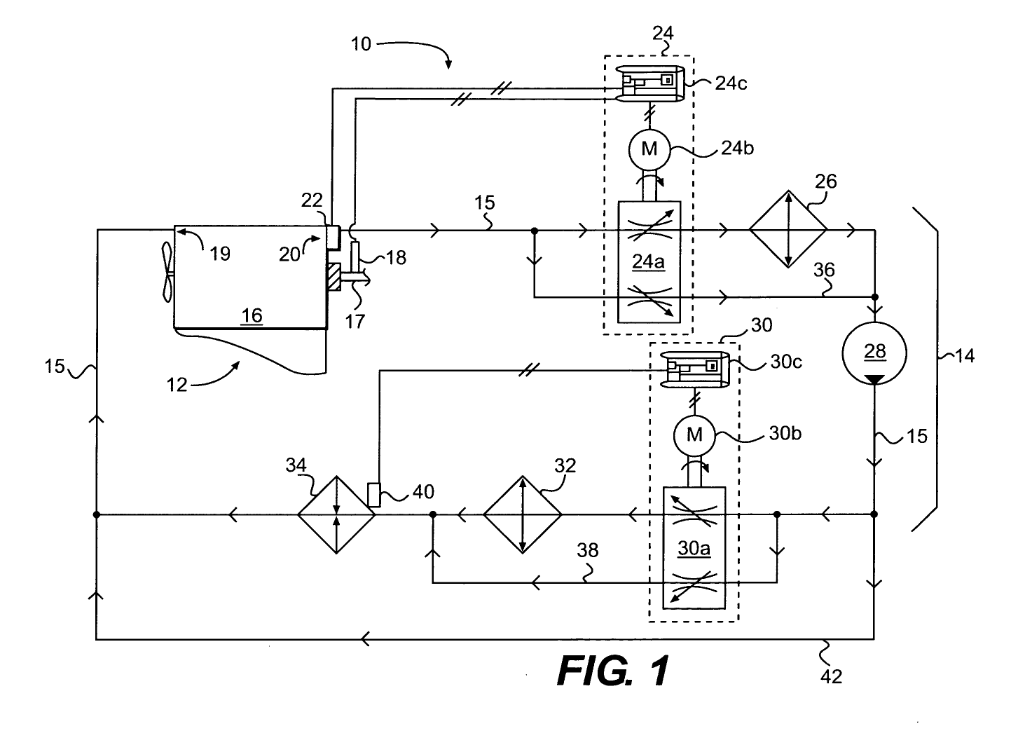

FIG. 1 illustrates a cooling system 10. Although referred to as a “cooling system,” it should be appreciated that cooling system 10 may function to both heat and cool components, as is known in the art. Cooling system 10 may include a heat source 12 and a main cooling circuit 14. Heat source 12 may transfer heat to a coolant fluid such as, for example, water, glycol, a water/glycol mixture, a blended air mixture, or any other coolant fluid known in the art. The coolant fluid may be driven to circulate through a pipeline 15 of main cooling circuit 14 to deliver heat to and/or absorb heat from heat source 12 and one or more other components of cooling system 10. Although referred to herein as a “pipeline,” it should be appreciated that pipeline 15 may embody any fluid-conveying passageway.

Heat source 12 may embody an engine having multiple components that cooperate to combust a fuel/air mixture and produce a power output. For example, heat source 12 may be a diesel engine, a gasoline engine, or a gaseous fuel-powered engine having an engine block 16 and a crankshaft 17. Engine block 16 may define a plurality of cylinders (not shown), a piston (not shown) slidably disposed within each cylinder, and a cylinder head associated with each cylinder. Heat source 12 may draw the fuel/air mixture into each cylinder, compress the mixture with the piston, and ignite the compressed mixture to produce a combination of mechanical power, heat, and exhaust.

The mechanical power output of heat source 12 may embody a rotation of crankshaft 17 and may be characterized by a speed and a torque. Crankshaft 17 may thus be operable to drive a mechanical load to propel an associated machine. It should be appreciated that the mechanical load may be proportionally related to the speed and/or torque of the mechanical output of heat source 12. It should also be appreciated that heat source 12 may be associated with a maximum mechanical load that can be driven by crankshaft 17, and that the maximum mechanical load may be represented as a maximum speed, a maximum torque, and/or a maximum combination of speed and torque (i.e. a power level) of the mechanical output of heat source 12.

A sensor 18 may be associated with heat source 12 to sense an amount of the mechanical load driven by heat source 12. More specifically, sensor 18 may sense a rotational speed and/or torque delivered by crankshaft 17. In one example, sensor 18 may embody a magnetic pickup type of sensor associated with a magnet embedded within a rotational component of crankshaft 17. During operation of heat source 12, sensor 18 may sense the rotating magnetic field produced by the magnet and generate a signal corresponding to the rotational speed of crankshaft 17. It should be appreciated that sensor 18 may alternatively sense the mechanical load driven by heat source 12 by sensing a torque delivered by heat source 12, such as, for example, by a flywheel of heat source 12. The torque delivered by heat source 12 may be sensed based on, for example, a fuel rate and/or a fuel injection timing of heat source 12, as is known in the art. The signal generated by sensor 18 may embody any type of signal known in the art, such as, for example, a voltage signal, a current signal, or an encoded data signal. One skilled in the art will appreciate that sensor 18 may additionally or alternatively include an engine control module (not shown) configured to determine the amount of mechanical load driven by heat source 12, the rotational speed of crankshaft 17, and/or the torque delivered by heat source 12.

Heat source 12 may include an internal coolant circuit (not shown) to direct coolant fluid through heat source 12. Thus, coolant fluid may absorb heat from heat source 12 to cool heat source 12, or deliver heat to heat source 12 to warm heat source 12, depending on a temperature of the coolant fluid relative to a temperature of heat source 12. As such, heat source 12 may include a coolant inlet 19 and a coolant outlet 20, through which the coolant fluid may enter and exit heat source 12, respectively.

A temperature sensor 22 may be located at or near coolant outlet 20 to measure a temperature of the coolant fluid exiting heat source 12 (i.e. a top-tank temperature). That is, temperature sensor 22 may be in direct communication with the coolant fluid exiting heat source 12, and may be located within the internal coolant circuit of heat source 12, coolant outlet 20, or pipeline 15. It is contemplated that temperature sensor 22 may alternatively be in mechanical communication with a heat conducting component of heat source 12, coolant outlet 20, or pipeline 15. Temperature sensor 22 may embody any type of temperature sensor known in the art, such as, for example, a thermistor, and may generate a signal indicative of the measured temperature. The signal may embody any type of signal known in the art, such as, for example, a voltage signal, a current signal, or an encoded data signal.

Main cooling circuit 14 may include a first electrically-controlled valve 24, a first heat exchanger 26, a fluid pump 28, a main bypass line 42, a second electrically-controlled valve 30, a second heat exchanger 32, and an oil cooler 34. Coolant fluid may be driven by fluid pump 28 to flow through the components of main cooling circuit 14 to deliver heat thereto and absorb heat therefrom. For example, the coolant fluid may deliver heat to first heat exchanger 26 and/or second heat exchanger 32 to reduce a temperature of the coolant fluid. In contrast, the coolant fluid may receive heat from heat source 12 and/or oil cooler 34 to reduce a temperature of heat source 12 and/or engine oil within oil cooler 34. It should be appreciated that main cooling circuit 14 may include any number of other heat exchangers and/or coolant passageways, as is known in the art. For example, main cooling circuit 14 may include an exhaust gas recirculation cooler, a charge air cooler, a transmission cooler, a brake system cooler, and bypass lines to deliver coolant fluid to one or more of these heat exchangers. It should also be appreciated that main cooling circuit 14 may include any number of cooling fans operable to drive air to pass over or through one or more of the heat exchangers of main cooling circuit 14 in order to cool the heat exchangers, as is known in the art. It should further be appreciated that main cooling circuit 14 may include one or more supervisory controllers communicatively (not shown) coupled with, for example, first electrically-controlled valve 24, second electrically-controlled valve 30, and/or an engine control module of heat source 12 to at least partially control the operation of main cooling circuit 14.

First electrically-controlled valve 24 may be located downstream of heat source 12 to selectively direct portions of the coolant fluid from heat source 12 to first heat exchanger 26 and a first bypass line 36. That is, first electrically-controlled valve 24 may direct all or a portion of the coolant fluid from heat source 12 through first bypass line 36 so that the coolant fluid may retain its temperature (i.e. the coolant fluid passed through first bypass line 36 may not be cooled by first heat exchanger 26). As such, first electrically-controlled valve 24 may include a valve element 24a, a motor 24b, and a controller 24c. Although shown as being located upstream of first heat exchanger 26, it should be appreciated that first electrically-controlled valve 24 may alternatively be located downstream of first heat exchanger 26. It also should be appreciated that commercially available electrical thermostats and other similar devices can be configured to perform the functions of first electrically-controlled valve 24.

Valve element 24a may generally control the flow of coolant fluid from heat source 12 into first heat exchanger 26 and first bypass line 36. More specifically, valve element 24a may embody one or more movable parts positionable to selectively block or allow a first portion of the flow of coolant fluid through first heat exchanger 26 and a remaining portion of the flow of coolant fluid through first bypass line 36. In one example, valve element 24a may be movable to a first position to allow substantially all of the coolant fluid from heat source 12 to flow through first heat exchanger 26. In another example, valve element 24a may be movable to a second position to allow substantially all of the coolant fluid from heat source 12 to flow through first bypass line 36. In yet another example, valve element 24a may be movable to a third position between the first and second positions to allow the first portion of the coolant fluid to flow through first heat exchanger 26 and the remaining portion of the coolant fluid to flow through first bypass line 36. It should be appreciated that the third position may embody any number of positions between the first and second positions. The position of valve element 24a may be electronically regulated by controller 24c, and mechanically driven by motor 24b. One skilled in the art will appreciate, however, that valve element 24a may alternatively be driven hydraulically, pneumatically, or in any other manner known in the art. It is contemplated that valve element 24a may alternatively embody a plurality of valve elements 24a, if desired.

Motor 24b may be mechanically coupled to valve element 24a to drive a movement of valve element 24a. For example, motor 24b may produce a mechanical power output in the form of a rotating element, which may drive the movement of valve element 24a. It is contemplated that the rotating element may be mechanically coupled to valve element 24a by any means known in the art, such as, for example, by way of a gear train. Motor 24b may also be communicatively coupled to receive a command signal from controller 24c. The command signal may generally be indicative of a desired position of valve element 24a and may embody, for example, a data signal including at least one of a desired position of valve element 24a, a desired output torque of motor 24b, a desired output speed of motor 24b, and a time interval over which to drive valve element 24a. The command signal may alternatively embody a voltage or current signal. It should be appreciated that the command signal may embody any command signal suitable to control the output of motor 24b and/or the position of valve element 24a. For example, motor 24b may be operable to receive a forward enable command signal and a reverse enable command signal such that motor 24b may drive a clockwise output or a counter-clockwise output when the forward enable command signal or the reverse enable command signal is applied, respectively.

Controller 24c may determine a desired position of valve element 24a, generate the command signal to drive motor 24b, and deliver the command signal to motor 24b. As such, controller 24c may embody a single microprocessor or multiple microprocessors that include a means for controlling the position of valve element 24a. For example, controller 24c may include a memory, a secondary storage device, and a processor, such as a central processing unit or any other means for processing the input signals. Numerous commercially available microprocessors, microcontrollers, digital signal processors (DSPs), and other similar devices including field programmable gate arrays (FPGAs) programmed to act as a processor can be configured to perform the functions of controller 24c. It should be appreciated that controller 24c may include one or more of an application-specific integrated circuit (ASIC), an FPGA, a computer system, and a logic circuit, configured to allow controller 24c to function in accordance with the present disclosure. Thus, the memory of controller 24c may embody, for example, the flash memory of an ASIC, flip-flops in an FPGA, the random access memory of a computer system, or a memory circuit contained in a logic circuit. Controller 24c may additionally or alternatively be communicatively coupled with any other devices such as, for example, an external computer system, an engine control module of heat source 12, and/or one or more supervisory controllers of main cooling circuit 14. It should be appreciated that some or all of the functionality of controller 24c may alternatively be carried out by one or more supervisory controllers of main cooling circuit 14, and that controller 24c may be omitted entirely, if desired.

The desired position of valve element 24a may be based on an operating parameter of heat source 12 and main cooling circuit 14. For example, controller 24c may be communicatively coupled with sensor 18 and/or temperature sensor 22 to receive the signals generated thereby. Additionally or alternatively, controller 24c may be communicatively coupled with a temperature sensor (not shown) similar to temperature sensor 22 and included in first electrically-controlled valve 24 to receive a signal indicative of a temperature of the coolant fluid at or near first electrically-controlled valve 24. It is contemplated that controller 24c may further receive signals indicative of any number of other operating parameters such as, for example, temperatures of one or more components of main cooling circuit 14. Controller 24c may include, stored in its memory, one or more algorithms operable to generate the command signal to drive motor 24b based on the signals received by controller 24c. For example, the memory of controller 24c may include a predetermined range of top-tank temperatures (i.e. temperatures of coolant fluid exiting heat source 12) associated with optimal operation of heat source 12. Additionally or alternatively, the memory of controller 24c may include a map or other relationship to determine an optimal top-tank temperature range based on a monitored parameter such as, for example, the level of mechanical load, as sensed by sensor 18.

First heat exchanger 26 may embody a primary radiator (i.e., high temperature radiator) of heat source 12 and may be situated to dissipate heat from the coolant fluid after it has circulated throughout heat source 12. First heat exchanger 26 may be a liquid-to-air heat exchanger. It should be appreciated that cooling system 10 may include a fan located proximal to first heat exchanger 26 to generate a flow of air across or through first heat exchanger 26 to absorb heat from the coolant fluid.

Fluid pump 28 may be located downstream of first heat exchanger 26 to generate the flow of coolant fluid through main coolant circuit 14. Fluid pump 28 may be engine driven to generate the flow of coolant fluid through main coolant circuit 14. Fluid pump 28 may include an impeller (not shown) disposed within a volute housing having an inlet and an outlet. As the coolant fluid enters the volute housing, blades of the impeller may be rotated by operation of heat source 12 to push against the coolant fluid, thereby pressurizing the coolant fluid. A torque imparted by heat source 12 to fluid pump 28 may be related to a pressure of the coolant, while a speed imparted to fluid pump 28 may be related to a flow rate of the coolant fluid. It is contemplated that fluid pump 28 may alternatively embody a piston type pump, if desired, and may have a variable or constant displacement. It is further contemplated that fluid pump 28 may be electrically driven, mechanically driven, or driven in any other manner known in the art. It should also be appreciated that fluid pump 28 may alternatively be positioned in any other location of main cooling circuit 14 such that fluid pump 28 may drive the flow of coolant fluid through main cooling circuit 14.

Main bypass line 42 may direct a portion of the coolant fluid from fluid pump 28 around second electrically-controlled valve 30, second heat exchanger 32, and oil cooler 34. That is, main bypass line 42 may direct a first portion of the coolant fluid from fluid pump 28 to heat source 12, while a remaining portion of the coolant fluid from fluid pump 28 may be directed to second electrically-controlled valve 30. Although not shown, it should be appreciated that an amount of the coolant fluid directed through main bypass line 42 may be at least partially determined by a valve. Alternatively or additionally, the amount of the coolant fluid directed through main bypass line 42 may be determined by a flow-restriction characteristic of main bypass line 42. That is, main bypass line 42 may embody, for example, a fixed-restriction fluid passageway or a variable-restriction fluid passageway. It is contemplated that the temperature of the coolant fluid passing through main bypass line 42 may remain substantially constant. Alternatively, however, main bypass line 42 may include one or more heat-exchangers configured to transfer heat to and/or receive heat from the coolant fluid passing through main bypass line 42. For example, main bypass line 42 may include one or more of an exhaust gas recirculation cooler, a charge air cooler, a transmission cooler, and a brake system cooler. It should be appreciated that main bypass line 42 may alternatively embody a plurality of bypass lines, if desired.

Second electrically-controlled valve 30 may be located downstream of fluid pump 28 to selectively direct portions of the coolant fluid to second heat exchanger 32 and a second bypass line 38. That is, second electrically-controlled valve 30 may direct all or a portion of the remaining coolant fluid from fluid pump 28 (i.e. the portion of the coolant fluid not directed through main bypass line 42) through second bypass line 38. It should be appreciated that the coolant fluid directed through second bypass line 38 may retain its temperature (i.e. the coolant fluid passed through second bypass line 38 may not be cooled by second heat exchanger 32). As such, second electrically-controlled valve 30 may include a valve element 30a, a motor 30b, and a controller 30c. Although shown as being located upstream of second heat exchanger 32, it should be appreciated that second electrically-controlled valve 30 may alternatively be located downstream of second heat exchanger 32. It should also be appreciated that commercially available electrical thermostats and other similar devices can be configured to perform the functions of second electrically-controlled valve 30.

Valve element 30a may generally control the flow of coolant fluid from fluid pump 28 into second heat exchanger 32 and second bypass line 38. More specifically, valve element 30a may embody one or more movable parts positionable to selectively block or allow a first portion of the flow of coolant fluid through second heat exchanger 32 and a remaining portion of the flow of coolant fluid through second bypass line 38. In one example, valve element 30a may be movable to a first position to allow substantially all of the coolant fluid from fluid pump 28 to flow through second heat exchanger 32. In another example, valve element 30a may be movable to a second position to allow substantially all of the coolant fluid from fluid pump 28 to flow through second bypass line 38. In yet another example, valve element 30a may be movable to a third position between the first position and the second position to allow the first portion of the coolant fluid to flow through second heat exchanger 32 and the remaining portion of the coolant fluid to flow through second bypass line 38. It should be appreciated that the third position may embody any number of positions between the first and second positions. The position of valve element 30a may be electronically regulated by controller 30c, and mechanically driven by motor 30b. One skilled in the art will appreciate, however, that valve element 30a may alternatively be driven hydraulically, pneumatically, or in any other manner known in the art. It is contemplated that valve element 30a may alternatively embody a plurality of valve elements 30a, if desired.

Motor 30b may be mechanically coupled to valve element 30a to drive a movement of valve element 30a. For example, motor 30b may produce a mechanical power output in the form of a rotating element, which may drive the movement of valve element 30a. It is contemplated that the rotating element may be mechanically coupled to valve element 30a by any means known in the art, such as, for example, by way of a gear train. Motor 30b may also be communicatively coupled to receive a command signal from controller 30c. The command signal may generally be indicative of a desired position of valve element 30a and may embody, for example, a data signal including at least one of a desired position of valve element 30a, a desired output torque of motor 30b, a desired output speed of motor 30b, and a time interval over which to drive valve element 30a. The command signal may alternatively embody a voltage or current signal. It should be appreciated that the command signal may embody any command signal suitable to control the output of motor 30b and/or the position of valve element 30a. For example, motor 30b may be operable to receive a forward enable command signal and a reverse enable command signal such that motor 30b may drive a clockwise output or a counter-clockwise output when the forward enable command signal or the reverse enable command signal is applied, respectively.

Controller 30c may determine a desired position of valve element 30a, generate the command signal to drive motor 30b, and deliver the command signal to motor 30b. As such, controller 30c may embody a single microprocessor or multiple microprocessors that include a means for controlling the position of valve element 30a. For example, controller 30c may include a memory, a secondary storage device, and a processor, such as a central processing unit or any other means for processing the input signals. Numerous commercially available microprocessors, microcontrollers, digital signal processors (DSPs), and other similar devices including field programmable gate arrays (FPGAs) programmed to act as a processor can be configured to perform the functions of controller 30c. It should be appreciated that controller 30c may include one or more of an application-specific integrated circuit (ASIC), an FPGA, a computer system, and a logic circuit, configured to allow controller 30c to function in accordance with the present disclosure. Thus, the memory of controller 30c may embody, for example, the flash memory of an ASIC, flip-flops in an FPGA, the random access memory of a computer system, or a memory circuit contained in a logic circuit. Controller 30c may additionally or alternatively be communicatively coupled with any other devices such as, for example, an external computer system, an engine control module of heat source 12, and/or one or more supervisory controllers of main cooling circuit 14. It should be appreciated that some or all of the functionality of controller 30c may alternatively be carried out by one or more supervisory controllers of main cooling circuit 14, and that controller 30c may be omitted entirely, if desired.

The desired position of valve element 30a may be based on an operating parameter of heat source 12 and main cooling circuit 14. For example, controller 30c may be communicatively coupled with sensor 18 and/or temperature sensor 22 to receive the signals generated thereby. Additionally or alternatively, controller 30c may be communicatively coupled with a temperature sensor 40 similar to temperature sensor 22 to receive a signal indicative of a temperature of oil cooler 34 and/or the engine oil within cooling system 10, or a temperature sensor (not shown) similar to temperature sensor 22 and included in second electrically-controlled valve 30 to receive a signal indicative of a temperature of the coolant fluid at or near second electrically-controlled valve 30. Controller 24c may include, stored in its memory, one or more algorithms operable to generate the command signal to drive motor 30b based on the signals received by controller 30c. For example, the memory of controller 30c may include a predetermined range of engine oil temperatures associated with optimal operation of heat source 12. Additionally or alternatively, the memory of controller 24c may include a map or other relationship to determine an optimal engine oil temperature range based on a monitored parameter such as, for example, the level of mechanical load, as sensed by sensor 18.

Second heat exchanger 32 may embody a secondary radiator (i.e., low temperature radiator) of heat source 12 and may be situated to dissipate heat from the coolant fluid after it has circulated throughout heat source 12 and before circulating throughout oil cooler 34. Second heat exchanger 32 may be a liquid-to-air heat exchanger. It should be appreciated that cooling system 10 may include a fan located proximal to second heat exchanger 32 to generate a flow of air across or through second heat exchanger 32 to absorb heat from the coolant fluid.

Oil cooler 34 may be located downstream of second heat exchanger 32, and may embody any heat exchanger configured to transfer heat from the engine oil of heat source 12 to the coolant fluid. For example, oil cooler 34 may be any type of liquid-to-liquid heat exchanger such as, for example, a flat plate type heat exchanger, or a tube and bundle-type heat exchanger. Oil cooler 34 may be situated to cool engine oil directed through heat source 12 for lubrication and/or cooling purposes. Although shown downstream of second bypass line 38, it should be appreciated that oil cooler 34 may be positioned anywhere downstream of second heat exchanger 32, regardless of bypass line 38. Alternatively, oil cooler 34 may be positioned within heat source 12.

### INDUSTRIAL APPLICABILITY

The disclosed cooling system may be used in any machine or power system application that requires precise control over operating temperatures. In particular, the disclosed system may provide a simple and accurate way to control temperatures that a heat source and the lubricating oil passing through the heat source experience by measuring coolant temperatures at various locations within a coolant circuit, and regulating a flow of coolant fluid through multiple heat exchangers based on those temperatures. The operation of cooling system 10 will now be described.

During operation of cooling system 10, coolant fluid may flow through main cooling circuit 14. In particular, fluid pump 28 may drive coolant fluid to flow through main cooling circuit 14, including heat source 12 and oil cooler 34. More specifically, coolant fluid may flow through heat source 12 to deliver heat to or absorb heat from heat source 12, depending on a temperature of heat source 12 relative to a temperature of the coolant fluid. As the coolant fluid exits heat source 12, the top-tank temperature may be measured by temperature sensor 22 at coolant outlet 20. As discussed above, heat source 12 may generally receive a mixture of air and fuel, and combust this mixture to drive a rotation of crankshaft 17. As crankshaft 17 rotates to drive a mechanical load, sensor 18 may generate a signal indicative of an amount of the mechanical load (e.g. a rotational speed and/or torque delivered by crankshaft 17).

After exiting heat source 12, the coolant fluid may then pass through first electrically-controlled valve 24, which may allow a first portion of the coolant fluid to flow through first heat exchanger 26 and a remaining portion of the coolant fluid to flow through first bypass line 36. First heat exchanger 26 may cool the coolant fluid flowing therethrough by transferring heat from the coolant fluid to the ambient air about first heat exchanger 26. As discussed above, a cooling fan may be included to supplement the cooling of the coolant fluid by reducing a temperature of the ambient air and/or increasing a flow of the ambient air.

The amount of coolant fluid allowed to flow through first heat exchanger 26 may be at least partially dependent on the amount of mechanical load measured by sensor 18, the top-tank temperature measured by temperature sensor 22, and/or a temperature of the coolant fluid at or near first electrically-controlled valve 24. More specifically, based on the measured mechanical load, the measured top-tank temperature, and/or the temperature of the coolant fluid at or near first electrically-controlled valve 24, controller 24c may signal movement of valve element 24a to vary the coolant fluid flow through or around first heat exchanger 26. In particular, the coolant fluid from downstream of heat source 12 may flow either through first heat exchanger 26 or around first heat exchanger 26 to thereby regulate a temperature of the coolant entering heat source 12. For example, controller 24c may receive the signal generated by sensor 18 and use the amount of mechanical load indicated thereby to determine a desired top-tank temperature and/or a range of optimal top-tank temperatures. If a desired top-tank temperature is 85 degrees (based on a currently measured load) and the measured top-tank temperature is 100 degrees, controller 24c may indicate to motor 24b that valve element 24a should be moved toward the first position of valve element 24a, thus permitting a greater amount of coolant fluid to flow through first heat exchanger 26 and be cooled by first heat exchanger 26. In contrast, if a desired top-tank temperature is 85 degrees and the measured top-tank temperature is 75 degrees, controller 24c may indicate to motor 24b that valve element 24a should be moved toward the second position of valve element 24a, thus permitting a greater amount of coolant to flow through first bypass line 36 and around first heat exchanger 26. Heat source 12 may be cooled to a greater extent when a larger amount of coolant fluid is allowed to pass through first heat exchanger 26. Likewise, heat source 12 may be warmed to a greater extent when less coolant fluid is allowed to pass through first heat exchanger 26. In this manner, the top-tank temperature may be kept within an optimal range, as defined by the currently measured load of heat source 12.

As the coolant fluid exits first heat exchanger 26, it may be combined with the coolant fluid flowing through first bypass line 36, and directed by pipeline 15 to main bypass line 42 and second electrically-controlled valve 30. That is, a first portion of the coolant fluid may be directed through main bypass line 42, while a remaining portion of the coolant fluid may be directed through second electrically-controlled valve 30, where the flow may be further divided. More specifically, second electrically-controlled valve 30 may allow a first portion of the coolant fluid flowing therethrough to flow through second heat exchanger 32 and a remaining portion of the coolant fluid to flow through second bypass line 38. Second heat exchanger 32 may cool the coolant fluid flowing therethrough by transferring heat from the coolant fluid to the ambient air about second heat exchanger 32. As discussed above, a cooling fan may be included to supplement the cooling of the coolant fluid by reducing a temperature of the ambient air and/or increasing a flow of the ambient air.

The amount of coolant fluid allowed to flow through second heat exchanger 32 may be at least partially dependent on the amount of mechanical load measured by sensor 18, the temperature of oil cooler 34 measured by temperature sensor 40, and/or a temperature of the coolant fluid at or near second electrically-controlled valve 30. More specifically, based on the measured mechanical load, the measured temperature at oil cooler 34, and/or the temperature of the coolant fluid at or near second electrically-controlled valve 30, controller 30c may signal movement of valve element 30a to vary the coolant fluid flow through or around second heat exchanger 32. In particular, the coolant fluid from downstream of first heat exchanger 26 may either flow through second heat exchanger 32 or around second heat exchanger 32 to regulate a temperature of the coolant entering oil cooler 34. For example, controller 24c may receive the signal generated by sensor 18 and use the amount of mechanical load indicated thereby to determine a desired oil temperature and/or a range of optimal oil temperatures. Alternatively, controller 24c may determine a desired oil temperature and/or a range of optimal oil temperatures regardless of the amount of mechanical load driven by heat source 12. If a desired temperature of the engine oil is 85 degrees and the temperature at oil cooler 34 is 100 degrees, controller 30c may indicate to motor 30b that valve element 30a should be moved toward the first position of valve element 30a, thus permitting a greater amount of coolant fluid to flow through second heat exchanger 32 and to be cooled by second heat exchanger 32. In contrast, if a desired temperature of the engine oil is 85 degrees and the measured temperature is 75 degrees, controller 30c may indicate to motor 30b that valve element 30a should be moved toward the second position of valve element 30a, thus permitting a greater amount of coolant to flow through second bypass line 38 and around second heat exchanger 32. The engine oil may be cooled to a greater extent when a larger amount of coolant fluid is allowed to pass through second heat exchanger 32. Likewise, the engine oil may be warmed to a greater extent when less coolant fluid is allowed to pass through second heat exchanger 32. In this manner, the temperature of the engine oil may be kept within an optimal range.

After passing through oil cooler 34, the portion of the coolant fluid directed through second electrically-controlled valve 30 may be combined with the portion of the coolant fluid directed through main bypass line 42. This combined coolant fluid may then be passed to heat source 12 via pipeline 15. It should be appreciated that, because the portion of the coolant fluid directed through main bypass line 42 may not be cooled, it may have a temperature hotter than that of the portion of the coolant fluid directed through second electrically-controlled valve 30 and oil cooler 34. As such, the temperature of the combined coolant fluid may be hotter than that of the coolant fluid directed through oil cooler 34. In this manner, the combined coolant fluid may serve to warm heat source 12 and/or maintain a temperature of heat source 12 that may be hotter than a temperature of the engine oil.

Electrically-controlled valves 24, 30 may generally operate as described above to keep engine and engine oil temperatures within respective optimal ranges. That is, as the mechanical load driven by heat source 12 changes during operation of heat source 12, electrically-controlled valves 24, 30 may control the flow of coolant fluid through first heat exchanger 26 and second heat exchanger 32, respectively, in order to regulate the top-tank temperature and the engine oil temperature. For example, for a given mechanical load on heat source 12, controllers 24c, 30c may receive measured temperatures from temperature sensors 22, 40, respectively. Controllers 24c, 30c may control valve elements 24a, 30a, respectively, to move in a manner that passes a sufficient amount of coolant through heat exchangers 26, 32 to maintain the measured temperatures within their respective predetermined temperature ranges associated with the given mechanical load. Therefore, if for example, the measured top-tank temperature (i.e., 100 degrees Celsius) drops below the predetermined temperature range of about 105-110 degrees, controller 24c may signal valve element 24a to allow more coolant fluid to bypass first heat exchanger 26 and thereby warm the coolant fluid to a temperature within the predetermined temperature range.

In a particular example, heat source 12 may be operated at a load of about 25% to 50% (i.e. a mechanical load placed upon heat source 12 may be about 25% to 50% of a maximum rated mechanical load). During this condition, operation of heat source 12 and/or main coolant circuit 14 may be most efficient with a relatively high top-tank temperature. For example, a volumetric efficiency of first heat exchanger 26 may be maximized with the relatively high top-tank temperature, as is known in the art. As such, it may be desirable to maintain the relatively high top-tank temperature, and controller 24c of first electrically-controlled valve 24 may control valve element 24a to direct less fluid through first heat exchanger 26 when the top-tank temperature measured by sensor 18 falls below a predetermined threshold value. However, the desired temperature of the engine oil may be substantially lower than the relatively high top-tank temperature. For example, oil may need to be cooled below the predetermined threshold temperature in order to maintain its lubrication efficiency and integrity. Thus, controller 30c may control valve element 30a to pass an amount of coolant fluid through second heat exchanger 32 to lower the temperature of the coolant fluid. This lower temperature coolant fluid may then pass through oil cooler 34, and receive heat therefrom to reduce the temperature of the oil. As discussed above, the lower temperature coolant fluid from oil cooler 34 may then combine with and be heated by the higher temperature coolant directed through main bypass line 42 before entering heat source 12. In this manner, the relatively high top-tank temperature may be substantially maintained, while simultaneously cooling the engine oil to maximize its characteristics.

The disclosed cooling system may provide a high efficiency cooling solution while minimizing cost and under-hood space. More specifically, because the cooling system may use only one pump and two electrically-controlled valves, installation and/or repairs of the system may be relatively inexpensive. Further, the limited number of components included in the cooling system may minimize the amount of under-hood space used by the cooling system.

The efficiency of the disclosed cooling system may further be maximized by the use of the electrically-controlled valves. Specifically, because the electrically-controlled valves may take into account a temperature of the engine oil when controlling the amount of fluid through the first and second heat exchangers, the cooling system may provide efficient cooling and/or heating of the engine and the oil under a variety of mechanical load conditions.

It will be apparent to those skilled in the art that various modifications and variations can be made to the disclosed cooling system without departing from the scope of the disclosure. Other embodiments of the cooling system will be apparent to those skilled in the art from consideration of the specification and practice of the cooling system disclosed herein. It is intended that the specification and examples be considered as exemplary only, with a true scope of the disclosure being indicated by the following claims and their equivalents.

What is claimed is:

1. A cooling system for use with a heat source, comprising:
an oil cooler;
a fluid pump configured to drive fluid through the cooling system;
a first heat exchanger;
a first bypass line configured to direct fluid from the heat source around the first heat exchanger;
a first electrically-controlled valve configured to selectively direct at least a portion of the fluid from the heat source to at least one of the first heat exchanger and the first bypass line based on a temperature of the fluid;
a second heat exchanger located downstream of and in series with the first heat exchanger;
a second bypass line configured to direct fluid around the second heat exchanger; and
a second electrically-controlled valve located upstream of the oil cooler and configured to selectively direct at least a portion of the fluid to at least one of the second heat exchanger and the second bypass line based on a temperature of oil.

2. The cooling system of claim 1, wherein the first electrically-controlled valve is configured to selectively direct at least a portion of the fluid to at least one of the first heat exchanger and the first bypass line further based on at least one of a temperature of the fluid exiting the heat source and a mechanical load of the heat source.

3. The cooling system of claim 2, further including a temperature sensor communicatively coupled with the first electrically-controlled valve and configured to generate and deliver a signal indicative of the temperature of the fluid exiting the heat source.

4. The cooling system of claim 1, wherein the second electrically-controlled valve is configured to selectively direct at least a portion of the fluid to at least one of the second heat exchanger and the second bypass line further based on at least one of a temperature of the fluid and a mechanical load of the heat source.

5. The cooling system of claim 1, further including a main bypass line configured to direct fluid around the second heat exchanger and the oil cooler.

6. The cooling system of claim 1, further including a temperature sensor communicatively coupled with the second electrically-controlled valve and configured to generate and a deliver a signal indicative of the temperature of the oil.

7. The cooling system of claim 1, wherein the first electrically-controlled valve is further configured to:
determine a desired fluid temperature range;
increase the amount of fluid directed to the first heat exchanger when the temperature of the fluid is greater than the desired fluid temperature range; and
decrease the amount of fluid directed to the first heat exchanger when the temperature of the fluid is less than the desired fluid temperature range.

8. The cooling system of claim 7, wherein the desired fluid temperature range is determined based on a mechanical load of the heat source.

9. The cooling system of claim 1, wherein the second electrically-controlled valve is further configured to:
determine a desired oil temperature range;
increase the amount of fluid directed to the second heat exchanger when the temperature of the oil is greater than the desired oil temperature range; and
decrease the amount of fluid directed to the second heat exchanger when the temperature of the oil is less than the desired oil temperature range.

10. The cooling system of claim 9, wherein the desired oil temperature range is determined based on a mechanical load of the heat source.

11. A method for managing the temperatures of a heat source and oil circulated through the heat source, comprising:
driving fluid through a main circuit;
selectively branching at least a portion of the fluid through at least one of a first branch and a second branch based on a temperature of the fluid;
cooling the fluid in the first branch;
joining the fluid from the first branch and the second branch;
selectively branching at least a portion of the fluid through at least one of a third branch and a fourth branch based on a temperature of the oil;
cooling the fluid in the third branch;
joining the fluid from the third branch and the fourth branch; and
cooling the oil.

12. The method of claim 11, wherein the step of cooling the oil includes transferring heat from the oil to the fluid.

13. The method of claim 11, wherein the step of selectively branching at least a portion of the fluid through at least one of a first branch and a second branch is based further on at least one of a temperature of the fluid exiting the heat source and a mechanical load of the heat source.

14. The method of claim 11, wherein the step of selectively branching at least a portion of the fluid through at least one of a third branch and a fourth branch is based further on at least one of a temperature of the fluid and a mechanical load of the heat source.

15. The method of claim 11, further including:
determining a desired fluid temperature range;
increasing the amount of fluid through the first branch when the temperature of the fluid is greater than the desired fluid temperature range; and
decreasing the amount of fluid through the first branch when the temperature of the fluid is less than the desired fluid temperature range.

16. The method of claim 15, wherein the desired fluid temperature range is determined based on a mechanical load of the heat source.

17. The method of claim 11, further including:
determining a desired oil temperature range;
increasing the amount of fluid through the third branch when the temperature of the oil is greater than the desired oil temperature range; and
decreasing the amount of fluid through the third branch when the temperature of the oil is less than the desired oil temperature range.

18. The method of claim 17, wherein the desired oil temperature range is determined based on a mechanical load of the heat source.

19. A cooling system, comprising:
an engine;
an oil cooler configured to cool oil circulated through the engine;
a fluid pump configured to drive fluid through the cooling system;
a first heat exchanger;
a first bypass line configured to direct fluid from the heat source around the first heat exchanger;
a first electrically-controlled valve configured to selectively direct at least a portion of the fluid from the heat source to at least one of the first heat exchanger and the first bypass line based on a temperature of the fluid exiting the engine;
a second heat exchanger located downstream of and in series with the first heat exchanger;
a second bypass line configured to direct fluid around the second heat exchanger; and
a second electrically-controlled valve located upstream of the oil cooler and configured to selectively direct at least a portion of the fluid to at least one of the second heat exchanger and the second bypass line based on a temperature of oil within the oil cooler.

20. The cooling system of claim 19, wherein the first electrically-controlled valve is configured to selectively direct at least a portion of the fluid to the first heat exchanger and the first bypass line further based on at least one of a temperature of the fluid and a mechanical load of the heat source.
